(19) United States
(12) Patent Application Publication
(10) Pub. No.: US 2014/0091227 A1
(43) Pub. Date: Apr. 3, 2014

(54) Neutron Sensor, a Neutron Sensing Apparatus Including the Neutron Sensor and Processes of Forming the Neutron Sensors

(71) Applicants: Kan Yang, Solon, OH (US); Peter R. Menge, Novelty, OH (US); Brian C. LaCourse, Pepperell, MA (US)

(72) Inventors: Kan Yang, Solon, OH (US); Peter R. Menge, Novelty, OH (US); Brian C. LaCourse, Pepperell, MA (US)

(21) Appl. No.: 14/038,440

(22) Filed: Sep. 26, 2013

Related U.S. Application Data
(60) Provisional application No. 61/705,813, filed on Sep. 26, 2012.

(51) Int. Cl. G01T 3/06

(52) U.S. Cl. CPC G01T 3/06
USPC 250/367; 250/486.1; 427/180

(57) ABSTRACT

A neutron sensor includes neutron-sensing particles and a scintillator coating surrounding the neutron-sensing particles. In an embodiment, the neutron-sensing particles include ⁶LiF particles, the scintillator coating includes ZnS, or both. In another embodiment, the scintillator coating can coat more than one neutron-sensing particle. In a further embodiment, the scintillator coating is formed on neutron-sensing particles using precipitation techniques or fluidized bed processing.

### CROSS-REFERENCE TO RELATED APPLICATION

This application claims priority under 35 U.S.C. §119(e) to U.S. Patent Application No. 61/705,813 entitled “Neutron Sensor, A Neutron Sensing Apparatus Including The Neutron Sensor And Processes Of Forming The Neutron Sensors,” by Yang et al., filed Sep. 26, 2012, which is assigned to the current assignee hereof and incorporated herein by reference in its entirety.

### FIELD OF THE DISCLOSURE

This disclosure relates to neutron sensors, neutron sensing apparatuses and processes of forming neutron sensors.

### DESCRIPTION OF RELATED ART

Scintillator-based detectors are used in a variety of applications, including research in nuclear physics, oil exploration, field spectroscopy, container and baggage scanning, and medical diagnostics. When a scintillator material of the scintillator-based detector is exposed to ionizing radiation, the scintillator material absorbs energy of incoming radiation and scintillates, remitting the absorbed energy in the form of photons. For example, a neutron detector can emit photons after absorbing a neutron. Further improvements of scintillator-based detectors are desired.

### BRIEF DESCRIPTION OF THE DRAWINGS

Embodiments are illustrated by way of example and are not limited by the accompanying figures.

FIG. 1 is an illustration of a neutron-sensing apparatus in accordance with an embodiment described herein.

FIG. 2 is a cross-sectional view of a neutron sensor in accordance with an embodiment described herein.

FIG. 3 is an illustration of a neutron-sensing particle surrounded by a scintillator coating that can be used in a neutron sensor in accordance with an embodiment described herein.

FIG. 4 is an illustration of neutron-sensing particles surrounded by a scintillator coating that can be used in a neutron sensor in accordance with an embodiment described herein.

FIG. 5 includes a depiction of a portion of a fluidized bed reactor that can be used with a chemical vapor deposition process described herein.

FIG. 6 includes a depiction of a portion of a fluidized bed reactor that can be used with a sol-gel process described herein.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the invention. The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The term “averaged,” when referring to a parameter, is intended to mean an average, a geometric mean, or a median value for the parameter.

The term “elemental” before an atomic element is intended to mean to the atomic form of the atomic element that is not part of a chemical compound. For example, elemental Zn refers to zinc in its atomic form and not as part of a zinc compound, such as ZnS.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

Neutron-sensitive particles can be coated with a scintillator coating. The coated particles can allow neutrons to pass through the scintillator coating and be captured by the neutron sensing particles, which in turn, emit charged particles. Energy of the charged particles can be captured by the scintillator coating, which in turn, emits scintillating light. In an embodiment, the coating can be formed by precipitation, and in another embodiment, the coating can be formed using a fluidized bed process, for example, chemical vapor deposition or a sol-gel process. The coated particles can be used in a neutron sensor or within a neutron sensing apparatus.

The coated particles obviate issues that occur with neutron sensors and neutron-sensing apparatuses that have separate neutron-sensing particles and scintillation particles as seen with conventional neutron sensors. Optimal sizes for each of the neutron-sensing particles and the scintillation particles can be very different. Thus, there is a risk that the neutron-sensing particles and scintillation particles may segregate before the particles are thoroughly mixed within a matrix material leading to poor light output. Unlike conventional neutron sensors and neutron-sensing apparatuses, for the coated particles as described herein, the neutron-sensing particles will not be segregated from the scintillator material because the scintillator coating is disposed on the neutron-sensing particles. Additionally, no significant bonding material will be interposed between the neutron-sensing and scintillation particles. Potentially less neutron-sensing and scintillator material may be used in a neutron sensor and still achieve an acceptable light output. Alternatively, higher light output may be achieved for substantially the same amount of neutron-sensing and scintillator materials in a comparable conventional neutron sensor or neutron-sensing apparatus. More details are provided below and are merely to illustrate some embodiments and not limit the concepts as described herein.

The coated particles can be used in a neutron sensor 110 that is part of a neutron sensing apparatus 100, as illustrated in FIG. 1. The neutron sensor is optically coupled to a photosensor 130 that includes a photomultiplier tube or a semiconductor-based photomultiplier. The photosensor 130 is electronically coupled to computational circuitry 150. The computational circuitry 150 can receive and analyze the pulse data from the photosensor 130 to determine a number of neutron counts, a level of neutron radiation based on the identified number of neutron events, perform pulse shape discrimination, perform another suitable function, or the like. Further, computational circuitry 150 can provide an indication of the number of neutron events, an indication of a level of neutron radiation, or provide other information to a user via an interface 160. For example, computational circuitry 150 can provide a visual display via interface 160 indicating a level of neutron radiation. The operation of the neutron sensing apparatus 100 is described in more detail following a description of an exemplary, non-limiting embodiment of the neutron sensor 110.

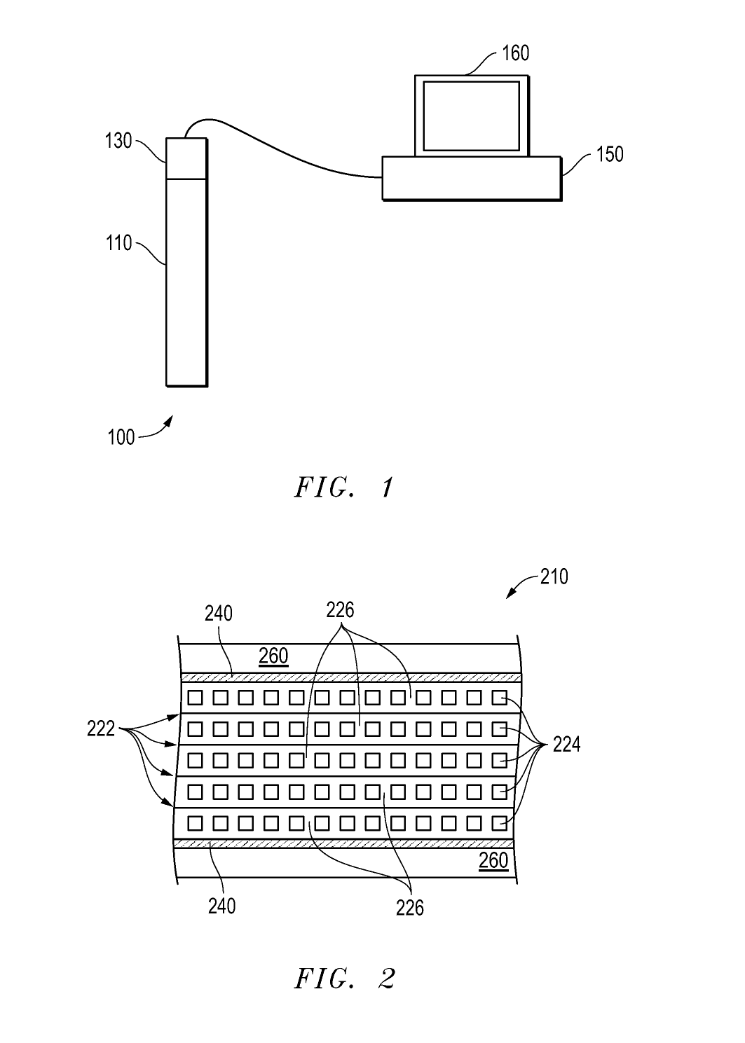

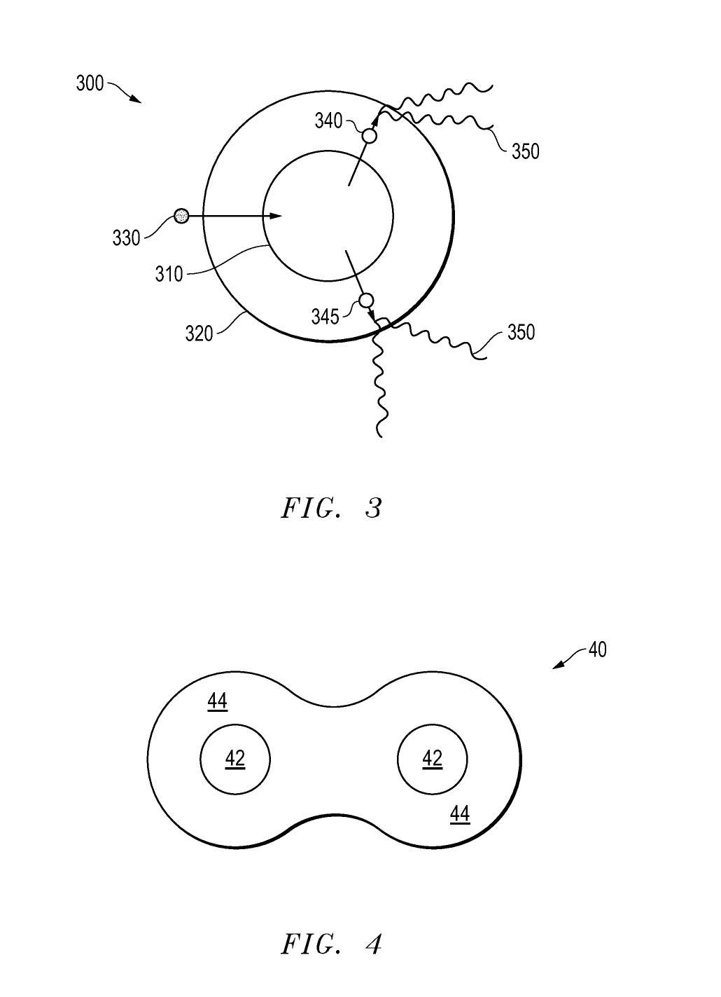

FIG. 2 includes a cross-sectional view of the neutron sensor 210 that includes phosphor layers 222, wherein the phosphor layers 222 include a matrix material in which the coated particles 300 are dispersed. Optical transmission members 224 are disposed on opposite sides of the phosphor layers 222. The optical transmission members 224 can transmit scintillating light or a derivative thereof, such as wavelength shifted light. As illustrated, the optical transmission members 224 are in the form of fibers. In another embodiment, the optical transmission members may be in the form of sheets between the phosphor layers 222. When a derivative of the transmitted light is to be received by the photosensor 130 (illustrated in FIG. 1), the optical transmission members 224 can be wavelength shifting fibers or wavelength shifting sheets. A reflector 240 surrounds the combination of the phosphor layers 222, the optical transmission members 224, and the clear epoxy 226 as illustrated in FIG. 2 to increase the likelihood that scintillating light from the phosphor layers 222 is received by the optical coupling members 224. Further illustrated in FIG. 2 is a neutron moderator 260 that can convert fast neutrons to thermal neutrons to increase the likelihood of capture by the phosphor layers 222. In another embodiment, a neutron moderator 260 is not required, as the optical coupling members may be configured to convert the fast neutrons to thermal neutrons. In a further embodiment (not illustrated), one or more of the wavelength shifting fibers 224 may be in contact with and surrounded by one of the phosphor layers 222.

FIG. 3 includes an illustration of a coated particle 300 in accordance with an embodiment described herein is provided. The coated particle 300 can includes a neutron-sensing particle 310 surrounded with a scintillator coating 320. Particular details regarding materials, particle sizes, thicknesses, and other considerations for the coated particles are described later in this specification.

The coated particle 300 can be configured such that neutron-sensing particle 310 can capture a target radiation, such as a neutron 330. The capture of the neutron 330 by the neutron-sensing particle 310 can produce one or more secondary particles, such as an alpha particle 340, a triton particle 345, another suitable secondary particle, or any combination thereof. The secondary particles 340, 345 can exit the neutron-sensing particle 310 and may lose a portion of their energy as they travel through neutron-sensing particle 310 or any other material. By surrounding neutron-sensing particle 310 with scintillator coating 320, the distance that secondary particles 340, 345 travel before reaching scintillator coating 320 can be reduced while the chance that secondary particles 340, 345 can be captured by scintillator coating 320 for conversion into photons can be increased. Upon capture of the secondary particles 340, 345, scintillator coating 320 can emit photons 350.

In operation, neutrons can be sensed as the neutron sensor 110 of the neutron-sensing apparatus 100. Fast neutrons, if any, that enter the neutron sensor are converted to thermal neutrons by the neutron moderator 260 (illustrated in FIG. 2). Thermal neutrons, if any, that enter the neutron sensor do not need to be converted to thermal neutrons by the neutron moderator 260, and therefore, pass through the neutron moderator 260. The thermal neutrons continue to migrate within the neutron sensor to the phosphor layers 222 that includes the coated particles 300. Referring to FIG. 3, a thermal neutron 330 passes through the scintillator coating 320 and can be captured by the neutron-sensing particle 310. Secondary particles 340, 345 can be emitted from the neutron-sensing particle 310 in response to capturing the neutron. The secondary particles 340, 345 can be captured by the scintillator coating 320 and emit scintillating light 350 in response to capturing the secondary particles 340, 345. Referring to FIG. 2, the scintillating light can leave the phosphor layer 222 and be received by an optical transmission member 224. The optical transmission member 224 can transmit the scintillating light to the photosensor 130 (illustrated in FIG. 1). In another embodiment, the optical transmission member 224 can convert the scintillating light to wavelength shifted light that hits the photosensor 130. Photons from the scintillating light or wavelength shifted light can be received by the photosensor 130, and the photosensor 130 generates an electronic pulse in response to receiving the photons. The electronic pulse is sent from the photosensor 130 and is received by the computational circuitry 150. The computational circuitry 150 can analyze or perform another function in response to receiving the electronic pulse from the photosensor 130. The computational circuitry can determine that a neutron has been captured and increment a neutron counter, determine a neutron radiation level, perform another suitable determination, analysis, or the like, or any combination thereof.

Particular designs for the neutron sensor 110 and neutron-sensing apparatus 100 have been described. Other neutron sensors and neutron-sensing apparatuses can be used with the coated particles 300. Thus, after reading this specification, skilled artisans will appreciate that the coated particles 300 can be implemented in many different neutron sensors and neutron-sensing apparatuses without departing from the scope of the present invention.

Attention is now directed to the coated particles that can be used in neutron sensors and neutron-sensing apparatuses. Neutron-sensing particles provide a substrate on which a scintillator coating will be formed. In an embodiment, neutron-sensing particles can include neutron responsive atoms such as ⁶ Li or ¹⁰B. In another embodiment, neutron-sensing particles can include a neutron responsive element that is in elemental form (not part of a compound) or as part of a halide compound, a phosphate compound, a silicate compound, or any combination thereof. For example, the neutron-sensing particle can include ⁶LiF, ⁶Li₃PO₄, ⁶Li₄SiO₄, elemental ¹⁰B, ¹⁰BN, a ¹⁰B oxide, ¹⁰B₄C, or any combination thereof. In an embodiment, neutron-sensing particles include ⁶LiF.

The neutron-sensing particles can include a variety of shapes, including spherical particles and non-spherical particles, and a variety of averaged particles sizes. The neutron-sensing particles have an averaged particle size so that neutrons can be captured. Still, the averaged particle size of the neutron-sensing particles should be relatively small to reduce energy lost by the secondary particles as they travel from the point of origin to another point outside of the neutron-sensing particles. The averaged particle size of spherical neutron-sensing particles is measured using the diameter of the particles. The averaged particle size of non-spherical neutron-sensing particles is measured using any other suitable dimensions, such as a length, a width, or a cube root of the volume of the particle. In an embodiment, the neutron-sensing particles have an averaged particle size of at least approximately 0.2 microns, such as at least approximately 0.5 microns, or such as at least approximately 0.9 microns. In another embodiment, the neutron-sensing particles have an averaged particle size of no greater than approximately 20 microns, such as no greater than approximately 9 microns, such as no greater than approximately 5 microns, or no greater than approximately 3 microns. For example, the neutron-sensing particles have an averaged particle size of at least approximately 0.2 microns and no greater than approximately 20 microns. In a further embodiment, the neutron-sensing particles have an averaged particle size within a range of approximately 1.1 microns to approximately 9.9 microns.

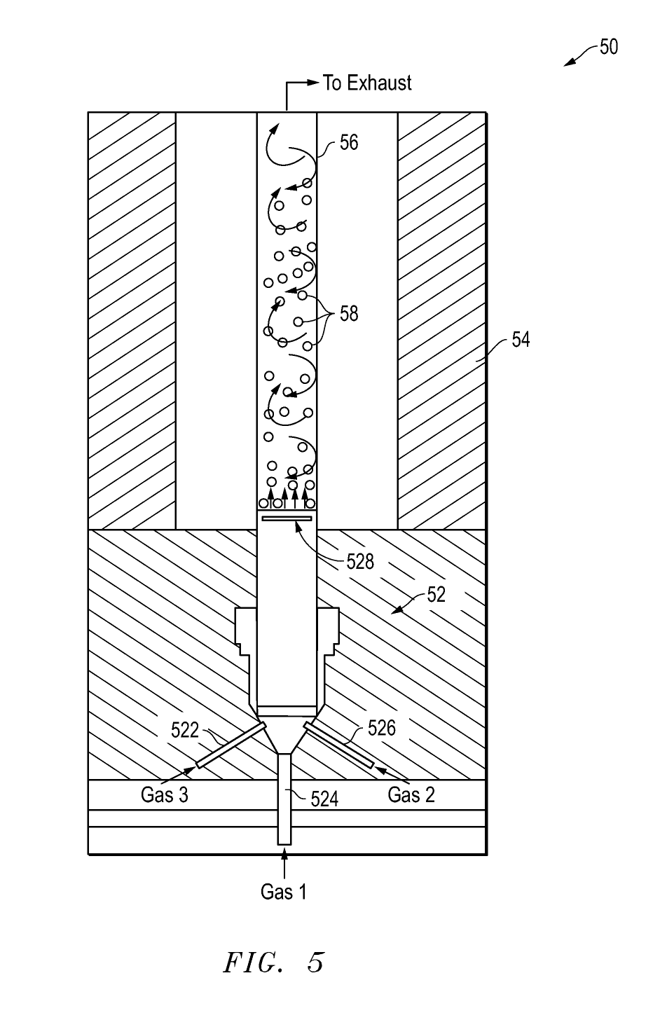

A scintillator coating surrounds the neutron-sensing particles. In an embodiment, the coated particle can include one neutron-sensing particle and a scintillator coating surrounding the neutron-sensing particle, such as illustrated in FIG. 3. In another embodiment as illustrated in FIG. 4, a coated particle can include two or more neutron-sensing particles 42 bonded or otherwise joined together and a scintillator coating 44 shared by and surrounding the two or more neutron-sensing particles. In a particular embodiment, the coated particle 40 can include neutron-sensing particles 42 that are spaced apart from one another and are coated with the same scintillator coating 44.

The scintillator coating can include any suitable scintillating material, including an inorganic scintillating compound, an organic scintillating compound, or any combination thereof, that produces photons in response to capturing a secondary particle. In an embodiment, the scintillator coating may have a relatively low sensitivity to gamma radiation.

Utilizing only elements having a low atomic number, such as below 50, even below 40, can reduce the sensitivity of the coated particles to gamma rays. For example, the scintillator coating can incorporate an inorganic substance such as a ZnS, a CdS, a ZnCdS, a ZnO, a MgS, a CaS, a SrS, a BaS, a yttrium aluminum garnet (YAG, Y₃Al₅O₁₂), a yttrium aluminum perovskite (YAP, YAlO₃), a MgF₂, a CaF₂, a CsF, a SrF₂, a BaF₂, a GSO, a Gd₂SiO₅, a CaWO₄, an Y₂SiO₅, any combination thereof, or another inorganic substance to produce scintillating light in response to capturing a secondary particle. In a particular embodiment, the scintillator coating includes ZnS. An example of an organic scintillating compound includes anthracene, a scintillating plastic, or another organic substance to produce scintillating light in response to capturing a secondary particle. Additionally, the scintillator coating can include a dopant or another added impurity, such as a transition metal, a rare earth metal, or another metal. For example, the scintillator coating can include ZnS:Ag, ZnS:Cu, Y₂SiO₅:Ce, ZnO:Ga, or ZnCdS:Cu. In a particular embodiment, the scintillator coating includes ZnS:Ag. In another particular embodiment, the scintillator coating includes ZnS:Cu.

The scintillator coating surrounding the neutron-sensing particles can include a sufficient thickness to allow charged particles to be captured and still allow a neutron to pass through the coating to the neutron-sensing particles. In an embodiment, the scintillator coating includes an averaged thickness of at least approximately 1.1 microns, such as at least approximately 2 microns, or such as at least approximately 5 microns. In another embodiment, the scintillator coating includes an averaged thickness of no greater than approximately 30 microns, such as no greater than approximately 20 microns, such as no greater than approximately 15 microns, or no greater than approximately 9 microns. In a further embodiment, the scintillator coating includes an averaged thickness within a range of approximately 1.1 microns to approximately 30 microns, or approximately 10 microns to approximately 30 microns. In surrounding the neutron-sensing particles, the scintillator coating may or may not be continuous around the entire surface of a neutron-sensing particle. In a particular embodiment, the scintillator coating is continuous around the entire surface of one or more neutron-sensing particles. In another embodiment, the scintillator coating is discontinuous around the entire surface of one or more neutron-sensing particles. In a further embodiment, the scintillator coating may surround at least approximately 50% of the surface of a neutron-sensing particle, such as at least approximately 75%, at least approximately 85%, at least approximately 95%, or even at least approximately 99% of the surface of a neutron-sensing particle.

Initially, neutron-sensing particles can be provided for the process in any suitable manner, including as part of a suspension such as an aqueous suspension or an organic suspension or the neutron-sensing particles by themselves. A scintillator coating can be formed over the neutron-sensing particles using a variety of different techniques, some of which are described herein for illustrative purposes and not to limit the present invention. After reading this specification, skilled artisan will be able to select a particular coating process for a particular application.

In an embodiment, the scintillator coating can be formed over the neutron-sensing particles by precipitating the scintillator coating onto the neutron-sensing particles. For example, the scintillator coating is formed by precipitation means using a plurality of precursors. The plurality of precursors can include a nitrate, a sulfate, a sulfide, a halide, an alkyl metal compound, an alkyl silizane, or any combination thereof, where an alkyl group within the alkyl metal compound or the alkyl silizane has 1 to 4 carbon atoms. The scintillator coating can be further formed using an activator precursor, such as a nitrate, a sulfate, a sulfide, a phosphite, a phosphate, a chloride, a halide, or any combination thereof. For example, an activator precursor includes silver (such as AgNO₃) or copper (CuCl₂) for a scintillator coating with ZnS.

In an embodiment, the scintillator coating can be formed over one or more neutron-sensing particles using precipitation and the application of heat. After the suspension with the neutron-sensing particles and precursors are combined, heat is applied to the resulting solution to assist in precipitating the scintillator coating onto the neutron-sensing particles. The temperature to be achieved with heating may depend on the particular solvent and precursors used. After the combination solution reaches an appropriate temperature for the reaction to form the scintillator coating to occur, the neutron-sensing particles may no longer be suspended after a sufficient amount of scintillator coating has been coated over neutron-sensing particles. In another embodiment, precipitation can occur by changing the pH of the combined solution. For example, a base may be added to the combined solution to raise the pH above 9. In a further embodiment, after the suspension with the neutron-sensing particles and one or more, but not all, of the coating precursors are combined, one or more of the remaining precursors may be slowly added. Precipitation may be performed at room temperature (for example, in a range of approximately 20° C. to approximately 25° C.) or at a higher temperature. The solutions can be agitated during the precipitation. For example, a mechanical or electromagnetic stirrer may be used.

After the scintillator coating is formed over the neutron-sensing particles, the coated particles can be separated from the remaining solution used in the coating process. Separation may be performed using a filter, centrifugal force, or another suitable separation technique. Any volatile components, such as organic materials, that may remain on the coated particles, can also be removed from the coated particles In a particular embodiment, drying may be performed with heat to remove any residual moisture or organic materials before the coated particles are combined with a matrix material.

In other embodiments, other coating processes can be used to form the scintillator coating over the neutron-sensing particles. For example, the coated particles can be made using a fluidized bed process. In one set of embodiments, a chemical vapor deposition (“CVD”) fluidized bed process can be used, and in another set of embodiments, a sol-gel fluidized bed process can be used. The different sets of embodiments are described in more detail below.

The fluidized bed reactor for the CVD process can include a grid and a deposition chamber. The grid is used to keep the granules in the hot zone of the fluidized bed and let the carrier gas and reaction gases flow through. A dust separator is optional and can be used to remove relatively fine particles from gases that are being exhausted from the fluidized bed reactor. For the CVD process, reactive gas inlets can be plumbed so that the reactive gases do not contact each other until the reactive gases are within the fluidized bed.

In one embodiment, a fluidized bed reactor 50 as illustrated in FIG. 5 can be used for the CVD process. The reactor includes a feed section 52, a heater 54, and a deposition chamber 56. As illustrated, the feed section 52 includes gas lines 522, 524, and 526, wherein different gases can be fed into the deposition chamber. In a particular embodiment where the scintillator coating includes ZnS, the gas line 522 can provide a zinc-containing source gas, the gas line 524 can provide a sulfur-containing source gas, and the gas line 526 can provide a carrier gas. In another embodiment, more or fewer gas inlets may be used. For example, a gas that includes a precursor for the activator may be provided using any of the previous gas lines or a different gas line. Still further, other compositions for scintillator coatings may be used. Precursors for such other compositions would be fed into the feed section 52 in place of the zinc-containing gas and the sulfur-containing gas in a manner similar to that described above. Although not illustrated, valves and controls are used to control the flow of gases in the gas lines 522, 524, and 526. The gases are kept separate before entering the reaction chamber 56.

The heater 54 is used to provide heat to the deposition chamber 56. The deposition chamber 56 includes a material that does not significantly react with the reaction or product gases within the deposition chamber 56. Because neutron-sensing particles 58 will contact the wall of the deposition chamber 56, the material along the inner surface may be abrasion resistant. In a particular embodiment, the material along the inner surface of the deposition chamber 56 may have a hardness that is harder than the material of the neutron-sensing particles 58 (before coating), the coating deposited onto the neutron-sensing particles 58, or both materials. In another particular embodiment, the material along the inner surface can include quartz, alumina, silicon nitride, aluminum nitride, or the like. In a particular embodiment, the deposition chamber 56 can consist essentially of any of the foregoing materials or may include a metal-containing tube with a liner that consists essentially of any of the foregoing materials. For example, the deposition chamber 56 can be quartz tube. The neutron-sensing particles 58 remain within the deposition chamber 56 during deposition, and gases exit the deposition chamber 56 and are sent to an exhaust.

The fluidized bed reactor 50 may operate as an open, atmospheric pressure reactor having an inert gas shower, such as N₂, a noble gas, CO₂ or any combination thereof, to help keep oxygen from outside the reactor 50 from entering the deposition chamber 56. In another embodiment, the fluidized bed reactor 50 can be a sealed system, which may allow reactant gas flows to be reduced compared to the open system. In a further embodiment, the fluidized bed reactor 50 may operate under vacuum.

FIG. 5 illustrates the neutron-sensing particles 58 as they are being coated with a scintillator coating in the reaction chamber 56 and become coated particles. The deposition chamber 56 can be charged with neutron-sensing particles 58 that are to be coated, and the deposition chamber 56 can be heated using the heater 54 to the desired reaction temperature. In an embodiment, the temperature can be at least approximately 300° C., and in another embodiment, the temperature can be less than approximately 800° C. The particular temperature may depend on the particular composition of the scintillator coating.

A gas flows through the gas line 526 through the orifice plate 528, and into the deposition chamber 56. The gas can flow at a rate sufficient to fluidize the bed. The gas can be relatively inert with respect to the neutron-sensing particles 58, the reactive gases, and coating to be formed on the neutron-sensing particles 58. The gas can include N₂, a noble gas, CO₂, or any combination thereof.

The reactive gas or gases can flow into the deposition chamber while the particles are fluidized. A metal-containing gas flows through the gas line 522 and another precursor gas flows through the gas line 524. In an embodiment, the metal-containing gas includes vapor of an elemental metal (for example, zinc), a metal nitrate, or an organometallic compound. The organometallic compound can include an alkyl or aryl metal, a metal alkoxide, or a metal acetate. In a particular embodiment for zinc, the metal-containing gas includes Zn (vapor), zinc nitrate, diisopropyl zinc, zinc diisobutoxide, di(cyclopentadienyl)zinc, Bis(i-propylcyclopentadienyl)zinc, diphenyl zinc, zinc acetate, or the like. In an embodiment wherein the scintillator coating includes a silver activator, the silver precursor may include isohexapropyl silver, silver isononoxide, (cyclopentadienyl)silver, isopropylcyclopentadienyl)silver, silver acetate, or the like. In a further embodiment wherein the scintillator coating includes a copper activator, the copper precursor may include diisopropyl copper, copper diisobutoxide, di(cyclopentadienyl)copper, Bis(i-propylcyclopentadienyl)copper, copper acetate, or the like.

The reactive gases can include a sulfur-containing gas. In a particular embodiment, the nitrogen-containing gas can include SH₂, an alkyl sulfide, a dialkyl sulfide, diarylthiosulfide, thiourea, another suitable sulfur-containing gas, or any combination thereof. In an embodiment, the alkyl group in the alkyl sulfide or each alkyl group within the dialkyl sulfur may have 1 to 6 carbon atoms.

The ratio of the metal-containing gas molar flow rate(s) to the other precursor gas molar flow rate may depend on the number of atoms within the compounds of the metal-containing gas and the other precursor gas. For example, on a per mole basis, (RS)₂S, wherein R is alkyl with 2 to 4 carbon atoms or phenyl or benzyl, can provide three times as much sulfur as H₂S. Many of the metal-containing gases include compounds that have only one metallic atom per compound. Thus, the product of the molar flow rate times the number of metal or sulfur in the compound can determine how much metal or sulfur is provided. A ratio of the metal-containing product (molar flow rate times the number of metal atoms within the metal-containing compound) to the other precursor product (molar flow rate times the number of nitrogen atoms within a nitrogen-containing compound) is at least approximately 1:500. In another embodiment, the ratio is less than approximately 1:2. In a particular embodiment, the ratio is in a range of approximately 1:150 to approximately 1:11. The previously described gases flowing into the fluidized bed reactor can form the coated particles that include the scintillator coating over the neutron-sensing particles 58. The flow of gases within the deposition chamber 56 is generally illustrated with arrows in FIG. 5. The coating can have any of the previously described properties, compositions, and thicknesses.

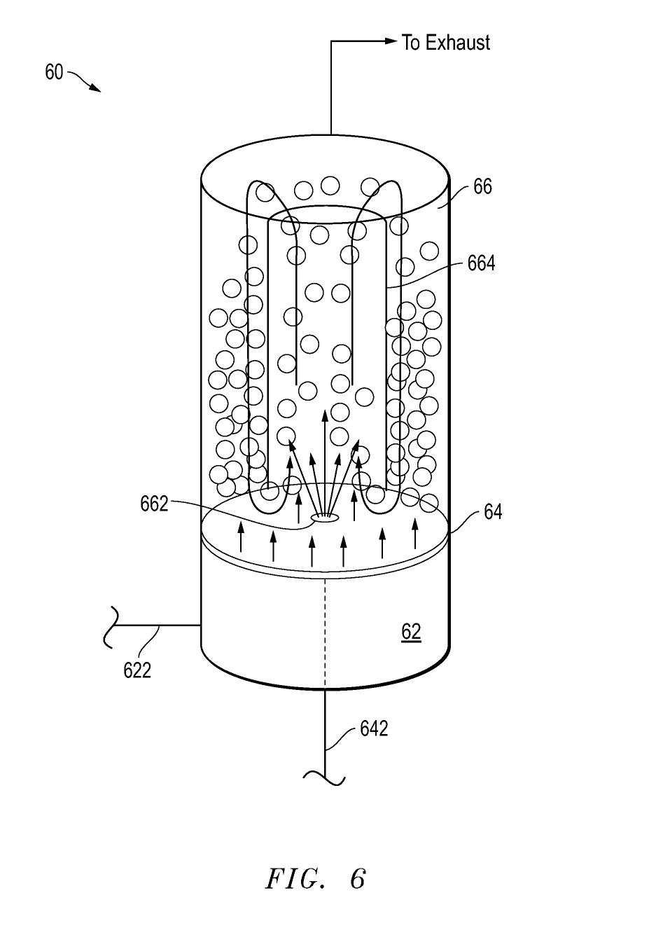

A sol-gel process can also be used to form the coated particles that include the neutron-sensing particles and the scintillator coating. In a particular embodiment, the Wurster process for coating the particles can be used. FIG. 6 includes an illustration of a fluidized bed reactor 60 that includes a plenum chamber 62, an orifice plate 64, and a deposition chamber 66. The orifice plate 64 is disposed between the plenum chamber 62 and the deposition chamber 66. A carrier gas feed line 622 provides any of the previously described carrier gases to the plenum chamber 62. A solution feed line 642 provides a solution for the sol-gel process to a nozzle 662 within the deposition chamber 66. A separator 664 within the deposition chamber separates a deposition region where deposition occurs and a return region where coated neutron-sensing particles return after passing through the deposition region. A relatively higher gas flow rate of the carrier gas flows though the deposition region as compared to the return region. A dust separator (not illustrated) is optional and can be used to remove relatively fine particles from gases that are being exhausted from the fluidized bed reactor 60.

The deposition chamber can be charged with neutron-sensing particles that are to be coated, and the deposition chamber can be heated to the desired temperature. The solution that will be used to coat the neutron-sensing particles can include a metal precursor and a solvent. The solvent can be water or an alcohol. Exemplary alcohols may have no more than 8 carbon atoms. In a particular embodiment, alcohols having 1 to 3 carbon atoms are used.

In a particular embodiment, the solution can include an alkyl or aryl metal, a metal alkoxide, a metal acetate or a metal nitrate in a solvent. In a more particular embodiment, the metal acetate can be a metal acetate hydrate. The solution may be stabilized with a hydroxylated component R—OH, such as alcohols, glycols, carboxylic acids (for example citric acid, acetic acid, or any other appropriate carboxylic acid) or -diketones, (for example, acetylacetone) or any combination thereof. During coating, the metal alkoxide may react with the water to form a metal oxide and an alcohol that can evaporate. In a particular embodiment, the metal alkoxide can be a methoxide, an ethoxide, a propoxide, or the like. In a more particular embodiment, the can be Zn*(NO₃)₂, Ag(OCH₂CH₃), Ag(OCH₂CH₂CH₂CH₃), or the like. Similar compounds may be used for the activator, and for silver, such compounds can include AgNO₃, Zn(OCH₂CH₃)₂, Zn(OCH₂CH₂CH₂CH₃), or the like.

In another particular embodiment, the solution can include a chlorinated metallic precursor in ethanol. In that case the chlorinated metallic precursor reacts exothermically with ethanol to form a metallic chloroethoxide and hydrochloric acid. Hydrolysis and condensation of the metallic chloroethoxide is ensured by water in environment air.

In a particular embodiment, organic additives can be added to adjust rheology of the solution or mechanical properties of the coatings. In a more particular embodiment, the organic additives can be polymer, such as polyethylene glycol or polyvinyl alcohol.

In an embodiment, the temperature used to coat the neutron-sensing particles may not exceed the boiling point of the solvent. When the solvent is water, the temperature may not exceed 100° C., when the solvent is ethanol, the temperature may not exceed 78° C., and when the solvent is 2-propanol, the temperature may not exceed 82° C. If the temperature is too low for the particular solvent used, the solvent may not vaporize sufficiently and the coated particles may stick together. The temperature may be selected to achieve a vapor pressure of approximately 90 mm Hg; the corresponding temperatures for water, ethanol, and 2-propanol are 50° C., 32° C., and 36° C., respectively. In a particular embodiment, when water is the solvent, the temperature can be at least approximately 70° C. or may be no greater than approximately 80° C. In another particular embodiment, when ethanol is the solvent, the temperature can be at least approximately 51° C. or may be no greater than approximately 60° C. In a further particular embodiment, when 2-propanol is the solvent, the temperature can be at least approximately 57° C. or may be no greater than approximately 65° C. After reading this specification, skilled artisans will appreciate that the temperature for the coating portion of the sol-gel process may depend at least in part on the solvent used in the solution.

When the solution includes a hydrolyzed metal alkoxide, the temperature can be selected such that it is closer to the boiling point of the corresponding alcohol (product of the hydrolysis) as compared to water.

In an alternative embodiment, the solution can include metal oxide particles in the metal alkoxide solution or alone in a solvent. The metal oxide can include any of the metallic elements previously described. The solvent can include any of the previously described solvents.

A gas flows into the plenum chamber 62, through the orifice plate 64, and into the deposition chamber 66. The gas can flow at a rate sufficient to fluidize the particles. The gas can be relatively inert with respect to the neutron-sensing particles, and the coating to be formed on the neutron-sensing particles. The gas can include any of the previously described gases with respect to the CVD process.

After the fluidized bed is at its desired temperature and the gas is flowing, the solution can be sprayed from a nozzle 662 that is located within or just above the orifice plate 64 near the middle (laterally) of the chamber. The solution coats the neutron-sensing particles, and the solvent or organic reaction product evaporates to leave a scintillator coating on the neutron-sensing particles. When the solution includes a zinc-based precursor or ZnS particles, a coating of ZnS is formed on the neutron-sensing particles. Other metal-based precursors or other particles for the scintillator coating can be used to coat the neutron-sensing particles. The thickness of the coating can be controlled by the deposition time, the concentration of the solution, the flow rate of the solution, or any combination thereof. Skilled artisans will appreciate that the foregoing variables may depend on the size or design of the particular fluidized bed used to coat the neutron-sensing particles.

The furnace may be used to dry the coating and to drive off any remaining solvent within the coating. The ambient used for the furnace can include a relatively inert gas. Any of the gases previously described with respect to the carrier gas may be used for the relatively inert gas during the furnace doping. The drying can be performed at substantially atmospheric pressure. In an embodiment, the drying temperature is at least approximately 500° C., and in another embodiment, the drying temperature is no greater than approximately 700° C. In an embodiment, the drying may be performed for a time period of at least approximately 0.5 hours, and in another embodiment, the drying may be performed for a time period no greater than approximately 4 hours.

While much of the description of the fluidized bed processes used to form scintillator coatings that include ZnS, the processes can be used to form other scintillator coatings. The selection of precursors or other starting materials for the fluidized bed may depend on the particular composition of the scintillator coating, temperature at which the coating is formed, or another suitable coating parameter. After reading this specification, skilled artisans will be capable of selecting compounds and determining parameters to coat the neutron-sensing particles with a scintillator coating.

The coated particles, including neutron-sensitive particles surrounded by a scintillator coating, can be put into a matrix material to form a phosphor layer. In an embodiment, the matrix material can be a polymer matrix including an epoxy, a polyvinyl toluene (PVT), a polystyrene (PS), a polymethylmethacrylate (PMMA), a polyvinylcarbazole (PVK), or any combination thereof. In a particular embodiment, the coated particles can be combined with a liquid precursor for the polymer matrix. The liquid precursor and the coated particles can be mixed to disperse the coated particles in the liquid precursor. The liquid precursor can be polymerized to form the polymer matrix. The polymerization of the liquid precursor can occur at a rate sufficient to substantially prevent the coated particles from settling out of the liquid precursor, ensuring the coated particles are substantially dispersed throughout the polymer matrix. The mixture of the liquid precursor and the coated particles can be poured into a mold prior to polymerization to provide the polymer matrix with a desired shape for the neutron sensor. Additionally, the combination of the polymer matrix and coated particles can be shaped after the polymer precursor(s) have polymerized, such as by cutting to a desired size or by milling away excess polymer.

At this point in the process, a phosphor layer has been formed. The phosphor layer can be as a component during the assembly of a neutron sensor, such as the neutron sensor 110 or phosphor layers 222 as previously described. The neutron sensor 110 can be incorporated as an assembly into a neutron-sensing apparatus, such as the neutron-sensing apparatus 100 as previously described.

The present invention has several advantages. First, a scintillator coating surrounds most, if not all, of the surface of one or more neutron-sensing particles. Most, if not all, secondary particles that result from a neutron-sensing particle receiving a neutron or other radiation can reach the scintillator coating, which can increase the efficiency of the neutron sensor in detecting secondary particles and yielding scintillation light. Second, since the neutron-sensing particle and the scintillator coating are bonded together, the two components do not segregate from one another during, for example, being cast in a polymer matrix. This bond can simplify the process of forming a neutron sensor and can improve its uniformity. Third, the secondary particles do not need to travel through a polymer matrix in order to interact with the scintillator coating, which can eliminate more of the energy loss of the secondary particles in the polymer matrix.

Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implemented using digital circuits, and vice versa. Embodiments may be in accordance with any one or more of the items as listed below. Embodiments may be in accordance with any one or more of the items as listed below.

Item 1. A neutron sensor comprising neutron-sensing particles, and a scintillator coating surrounding the neutron-sensing particles, wherein coated particles include the neutron-sensing particles surrounded with the scintillator coating.

Item 2. The neutron sensor of Item 1, further comprising a polymer matrix, wherein the coated particles are disposed within the polymer matrix.

Item 3. The neutron sensor of Item 1 or 2, further comprising an optical transmission member configured to receive scintillating light from the coated particles and to transmit the scintillating light or a derivative thereof along the optical transmission member.

Item 4. A neutron sensing apparatus comprising a phosphor layer comprising coated particles within a polymer matrix, wherein the coated particles include neutron-sensing particles surrounded by a scintillator coating; an optical transmission member configured to receive scintillating light from the phosphor layer and to transmit scintillating light or a derivative thereof along the optical transmission member; and a photosensor optically coupled to the optical transmission member.

Item 5. The neutron sensing apparatus of Item 4, wherein the photosensor is a photomultiplier tube or a semiconductor-based photomultiplier.

Item 6. A process of forming a neutron sensor comprising providing neutron-sensing particles; and forming a scintillator coating over the neutron-sensing particles.

Item 7. The process of Item 6, wherein forming the scintillator coating comprises precipitating the scintillator coating onto the neutron-sensing particles.

Item 8. The process of Item 7, wherein the scintillator coating is formed from a plurality of precursors.

Item 9. The process of Item 7, wherein the precursors comprise a nitrate, a sulfate, a sulfide, a halide, an alkyl metal compound, an alkyl silizane, or any combination thereof, wherein an alkyl group within the alkyl metal compound or the alkyl silizane has 1 to 4 carbon atoms.

Item 10. The process of Item 8 or 9, wherein the scintillator coating is further formed from an activator precursor.

Item 11. The process of any one of Items 6 to 10, wherein providing the neutron-sensing particles comprises providing a suspension including the neutron-sensing particles.

Item 12. The process of Item 11, wherein forming the scintillator coating comprises adding a first solution to the suspension, wherein the first solution includes at least one precursor for the scintillator coating.

Item 13. The process of Item 12, wherein forming the scintillator coating comprises adding a second solution to the suspension after adding the first solution to the suspension.

Item 14. The process of Item 12 or 13, further comprising heating the first solution and the suspension to cause the scintillator coating to precipitate onto the neutron-sensing particles.

Item 15. The process of Item 12 or 13, further comprising changing a pH of the first solution and the suspension to cause the scintillator coating to precipitate onto the neutron-sensing particles.

Item 16. The process of any one of Items 7 to 15, further comprising separating the coated particles from a remaining solution; and heating the coated particles to remove a volatile component from the coated particles.

Item 17. The process of Item 6, wherein forming the scintillator coating is formed by chemical vapor deposition.

Item 18. The process of Item 17, wherein forming the scintillator coating comprises fluidizing a bed of neutron-sensing particles within a fluidized bed reactor, flowing at least one precursor of the scintillator coating into the fluidized bed reactor, and depositing the scintillator coating onto the neutron-sensing particles.

Item 19. The process of any one of Items 6 to 18, further comprising adding the coated particles into a polymer matrix to form a phosphor layer.

Item 20. The process of Item 19, further comprising placing the phosphor layer adjacent to an optical transmission member.

Item 21. The neutron sensor, the neutron sensing apparatus, or the process of any one of the preceding Items, wherein the neutron-sensing particles have an averaged particle size of no greater than approximately 20 microns, no greater than approximately 9 microns, no greater than approximately 5 microns, or no greater than approximately 3 microns, or wherein the neutron-sensing particles have an averaged particle size of at least approximately 0.2 micron, at least approximately 0.5 microns, or at least approximately 0.9 microns.

Item 22. The neutron sensor, the neutron sensing apparatus, or the process of any one of the preceding Items, wherein the neutron-sensing particles have an averaged particle size in a range of approximately 0.2 microns to approximately 20 microns, or approximately 1.1 microns to approximately 9.9 microns.

Item 23. The neutron sensor, the neutron sensing apparatus, or the process of any one of the preceding Items, wherein the scintillator coating has an averaged thickness of no greater than approximately 30 microns, no greater than approximately 20 microns, no greater than approximately 15 microns, or no greater than approximately 9 microns, or wherein the scintillator coating has an averaged thickness of at least approximately 1.1 microns, at least approximately 2 microns, or at least approximately 5 microns.

Item 24. The neutron sensor, the neutron sensing apparatus, or the process of any one of the preceding Items, wherein the scintillator coating has an averaged thickness in a range of approximately 1.1 microns to approximately 30 microns, or approximately 10 microns to approximately 30 microns.

Item 25. The neutron sensor, the neutron sensing apparatus, or the process of any one of the preceding Items, wherein the neutron-sensing particles have an averaged particle size in a range of approximately 1.1 microns to approximately 9.9 microns, and the scintillator coating has an averaged thickness in a range of approximately 10 microns to approximately 30 microns.

Item 26. The neutron sensor, the neutron sensing apparatus, or the process of any one of the preceding Items, wherein a particular coated particle of the coated particles includes at least two neutron-sensing particles and a particular scintillator coating that is shared by the two neutron-sensing particles.

Item 27. The neutron sensor, the neutron sensing apparatus, or the process of any one of the preceding Items, wherein the neutron-sensing particles include ⁶Li or ¹⁰B.

Item 28. The neutron sensor, the neutron sensing apparatus, or the process of any one of the preceding Items, wherein the neutron-sensing particles include ⁶LiF.

Item 29. The neutron sensor, the neutron sensing apparatus, or the process of any one of Items 1 to 27, wherein the neutron-sensing particles include elemental ¹⁰B, ¹⁰BN, a ¹⁰B oxide, ¹⁰B₄C, or any combination thereof.

Item 30. The neutron sensor, the neutron sensing apparatus, or the process of any one of the preceding Items, wherein the scintillator coating includes a ZnS, a ZnO, a ZnCdS, a CdS, a CaS, a BaS, a SrS, a MgS, a MgF₂, a CaF₂, a CsF, a SrF₂, a BaF₂, a Y₃Al₅O₁₂, a YAlO₃, a Gd₂SiO₅, a CaWO₄, a Y₂SiO₅, or any combination thereof.

Item 31. The neutron sensor, the neutron sensing apparatus, or the process of any one of Items 2 to 5 and 19 to 30, wherein the polymer matrix includes an epoxy, a polyvinyl toluene, a polystyrene, a polymethylmethacrylate, a polyvinylcarbazole, or any combination thereof.

Item 32. The neutron sensor, the neutron sensing apparatus, or the process of any one of Items 3 to 5, and 20 to 31, wherein the optical transmission member is a wavelength shifting member.

Item 33. The neutron sensor, the neutron sensing apparatus, or the process of Item 32, wherein the wavelength shifting member is in a form of a wavelength shifting fiber or a wavelength shifting sheet.

Item 34. The neutron sensor, the neutron sensing apparatus, or the process of any one of Items 3 to 5, and 20 to 31, wherein the optical transmission member is not a wavelength shifting member.

Item 35. The neutron sensor, the neutron sensing apparatus, or the process of any one of the preceding Items, further comprising a moderator surrounding the coated particles, wherein the moderator is configured to convert fast neutrons to thermal neutrons.

### EXAMPLES

The concepts described herein will be further described in the following examples, which do not limit the scope of the invention described in the claims. Some of the parameters below have been approximated for convenience.

### Example 1

Example 1 demonstrates that a scintillator coating can be formed over neutron-sensing particles by using a solution that is heated to initiate formation of the coated particles. An aqueous zinc nitrate (Zn(NO₃)₂) solution can be added to an aqueous suspension that includes ⁶LiF particles as the neutron-sensing particles. Simultaneously or thereafter, thiacetamide (CH₃C(S)NH₂), is added to the aqueous suspension. The zinc nitrate and thiacetamide may be added in equimolar amounts. If needed or desired, an excess of one of the precursors may be added. The combined solution is agitated with an electromagnetic stirrer and heated to approximate 70° C. A ZnS coating forms over the ⁶LiF particles, and the coated particles fall out of the combined solution. The coated particles are separated from the combined solution and dried.

### Example 2

Example 2 demonstrates that a scintillator coating can be formed over the neutron-sensing particles by adding one of the precursors at a controlled rate to cause the scintillator coating to form on the neutron-sensing particles. An aqueous solution containing sodium sulfide (Na₂S) is added to an aqueous suspension including ⁶LiF particles. An aqueous solution containing zinc sulfate (ZnSO₄), is slowly added to the suspension and Na₂S solution. A ZnS coating forms over the ⁶LiF particles, and the coated particles fall out of the combined solution. The coated particles are separated from the combined solution and dried. Note that the precipitation can be performed at approximately room temperature. If needed or desired, the temperature during the precipitation may be adjusted.

### Example 3

Example 3 demonstrates that an organic solvent, rather than an aqueous solvent, may be used, and the temperature during precipitation can exceed 100° C. ⁶LiF particles are suspended in a mixture that includes at least trioctylphosphine oxide and trioctylphosphine in solution. Diethylzinc (Zn(C₂H₅)₂) and hexamethyldisilathiane ((CH₃)₃Si)₂S) are dissolved into the suspension solution containing the ⁶LiF particles. The diethylzinc and hexamethyldisilathiane may be added in equimolar amounts. If needed or desired, an excess of one of the precursors may be added. The combined solution is agitated with an electromagnetic stirrer and heated to a temperature within a range of approximately 140° C. to approximately 220° C. A ZnS coating forms over the ⁶LiF particles, and the coated particles fall out of the combined solution. The coated particles are separated from the combined solution and dried.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A neutron sensor comprising:
neutron-sensing particles; and
a scintillator coating surrounding the neutron-sensing particles,
wherein coated particles include the neutron-sensing particles surrounded with the scintillator coating.

2. The neutron sensor of claim 1, further comprising a polymer matrix, wherein the coated particles are disposed within the polymer matrix.

3. The neutron sensor of claim 1, further comprising an optical transmission member configured to receive scintillating light from the coated particles and to transmit the scintillating light or a derivative thereof along the optical transmission member.

4. The neutron sensor of claim 1, wherein the neutron-sensing particles have a median particle size of no greater than approximately 20 microns, no greater than approximately 9 microns, no greater than approximately 5 microns, or no greater than approximately 3 microns, or wherein the neutron-sensing particles have a median particle size of at least approximately 0.2 micron, at least approximately 0.5 microns, or at least approximately 0.9 microns.

5. The neutron sensor of claim 1, wherein the scintillator coating has an average thickness of no greater than approximately 30 microns, no greater than approximately 20 microns, no greater than approximately 15 microns, or no greater than approximately 9 microns, or wherein the scintillator coating has an average thickness of at least approximately 1.1 microns, at least approximately 2 microns, or at least approximately 5 microns.

6. The neutron sensor of claim 1, wherein:
the neutron-sensing particles have a median particle size in a range of approximately 1.1 microns to approximately 9.9 microns; and
the scintillator coating has an average thickness in a range of approximately 10 microns to approximately 30 microns.

7. The neutron sensor of claim 1, wherein a particular coated particle of the coated particles includes at least two neutron-sensing particles and a particular scintillator coating that is shared by the two neutron-sensing particles.

8. The neutron sensor of claim 1, wherein the neutron-sensing particles include ⁶Li or ¹⁰B.

9. The neutron sensor of claim 1, wherein the scintillator coating includes a ZnS, a ZnO, a ZnCdS, a CdS, a CaS, a BaS, a SrS, a MgS, a MgF₂, a CaF₂, a CsF, a SrF₂, a BaF₂, a Y₃Al₅O₁₂, a YAlO₃, a Gd₂SiO₅, a CaWO₄, a Y₂SiO₅, or any combination thereof.

10. The neutron sensor of claim 1, further comprising a moderator surrounding the coated particles, wherein the moderator is configured to convert fast neutrons to thermal neutrons.

11. A neutron sensing apparatus comprising:
a phosphor layer comprising coated particles within a polymer matrix, wherein the coated particles include neutron-sensing particles including ⁶Li or ¹⁰B surrounded by a scintillator coating;
an optical transmission member configured to receive scintillating light from the phosphor layer and to transmit scintillating light or a derivative thereof along the optical transmission member; and
a photosensor optically coupled to the optical transmission member.

12. The neutron sensing apparatus of claim 11, wherein the photosensor is a photomultiplier tube or a semiconductor-based photomultiplier.

13. The neutron sensing apparatus of claim 11, wherein the optical transmission member is a wavelength shifting member.

14. The neutron sensing apparatus of claim 11, wherein the optical transmission member is not a wavelength shifting member.

15. The neutron sensing apparatus of claim 11, wherein:
the neutron-sensing particles have a median particle size in a range of approximately 1.1 microns to approximately 9.9 microns; and
the scintillator coating has an average thickness in a range of approximately 10 microns to approximately 30 microns.

16. The neutron sensing apparatus of claim 11, wherein the scintillator coating includes a ZnS, a ZnO, a ZnCdS, a CdS, a CaS, a BaS, a SrS, a MgS, a MgF₂, a CaF₂, a CsF, a SrF₂, a BaF₂, a Y₃Al₅O₁₂, a YAlO₃, a Gd₂SiO₅, a CaWO₄, a Y₂SiO₅, or any combination thereof.

17. A process of forming a neutron sensor comprising:
providing neutron-sensing particles; and
forming a scintillator coating over the neutron-sensing particles.

18. The process of claim 17, wherein forming the scintillator coating comprises precipitating the scintillator coating onto the neutron-sensing particles.

19. The process of claim 17, wherein providing the neutron-sensing particles comprises providing a suspension including the neutron-sensing particles.

20. The process of claim 17, wherein forming the scintillator coating is formed by chemical vapor deposition.
